(19) United States
(12) Patent Application Publication
(10) Pub. No.: US 2007/0121155 A1
(43) Pub. Date: May 31, 2007

(54) Image reading apparatus and image processing system

(75) Inventor: Kenichi Machiyama, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 11/605,359

(22) Filed: Nov. 29, 2006

(30) Foreign Application Priority Data
Nov. 30, 2005 (JP) 2005-345970

(51) Int. Cl. G06F 3/12

(52) U.S. Cl. 358/1.15; 358/402

(57) ABSTRACT

An image reading apparatus which has a reading section for reading image information from an original image and transmits the read image information to a PC. A user information storing section preliminarily stores user information of the user who is presumed to use the image reading apparatus. An identifying section authenticates the user on the basis of a user ID inputted by the user who requests transmission of the image information and the user information stored in the user information storing section. When the identifying section authenticates the user, a network control section adds the user information to the read image information and transmits the image information added the user information to the PC.

### BACKGROUND OF THE INVENTION

1. Field of the Invention

The invention relates to an image reading apparatus for reading image information from an image of an original document, and an image processing system including the image reading apparatuses.

2. Description of the Related Art

Hitherto, an apparatus for inputting/outputting and transferring image information (for example, facsimile apparatus) is often used in common by a plurality of users. In the case where the apparatus is used in common as mentioned above, particularly, in a use environment in which many kinds of various terminal apparatuses are connected to a network, information showing a transmitting source and a transmission destination of the image information is important. Generally, although the transfer of the image information is executed by designating an address of a transmitting source apparatus and an address of a transmission destination apparatus, in the environment in which the transmitting source apparatus is operated by a plurality of users as mentioned above, there is also a case where it is intended to transfer the operator's information to the transmission destination. In such a case, hitherto, there has been opened such a related art that user information such as name, address, and the like is preliminarily registered every user who uses the transmitting source apparatus, and upon transmission of the image information, a desired one of the registered user information is selected and transmitted (refer to JP-A-1999 (Heisei 11)-284776.

According to the above conventional technique, the user information of each user registered in the apparatus can be used by all of the users of the apparatus. Therefore, a case where the user has transmitted the image information by using the wrong user information also occurs. It is also difficult to prevent what is called “impersonation” in which the malicious user intentionally transmits the image information by using the user information of the third party.

### SUMMARY OF THE INVENTION

It is an object of the invention to provide an image reading apparatus for reading image information from an image of an original document, an image transfer apparatus for transferring the received image information to another apparatus, and an image processing system including those apparatuses.

According to the present invention, there is provided an image reading apparatus which has an image reading section for reading image information from an image of an original document and transmits the image information read by the image reading section to a predetermined apparatus, comprising:

a user information storing section which preliminarily stores user information of a user who is presumed to use the image reading apparatus;

a user identifying section which authenticates the user on the basis of identification information that is inputted by the user who requests transmission of the image information and the user information stored in the user information storing section; and

a network control section which transmits the image information read by the image reading section to the predetermined apparatus,

wherein when the user identifying section authenticates the user, the network control section adds the user information of the user to the image information and transmits the resultant image information to the predetermined apparatus.

Moreover, in the image reading apparatus, the user information storing section may comprise an external storing apparatus which is detachably connected to the image reading apparatus.

Moreover, in the image reading apparatus, the external storing apparatus may have a user setting information storing section which stores information whose settings can be arbitrarily changed by the user.

Moreover, in the image reading apparatus, the user information storing section may store a user ID serving the identification information.

Moreover, the image reading apparatus may further comprise an operation panel to input the identification information.

Moreover, in the image reading apparatus, the user identifying section, when identified that an inputted user ID is different from the user ID stored in the user information storing section, may execute a display of a message on the operation panel.

Moreover, in the image reading apparatus, the user identifying section, when identified that an inputted user ID is coincident with the user ID stored in the user information storing section, may execute a display of a message indicating that the image information can be read on the operation panel.

Moreover, in the image reading apparatus, the user identifying section, when received a deletion instruction if the identification information from the operation panel, may execute a deletion of the identification information and may transmit a user information deletion end notification to the operation panel.

Moreover, the image reading apparatus may further comprise an interface section to connect an attachable and removable memory storing user information, wherein the interface section may monitor whether the attachable and removable memory is connected, if it is not, executes a display of memory connection waiting on the operation panel; and if it is, outputs a connection end notification.

Moreover, in the image reading apparatus, the user identifying section, when identified that an user ID contained in the user information stored in the attachable and removable memory is different from the user ID stored in the user information storing section, may transmit an identification failure notification and may execute a display of a message indicating the identification failure notification and a memory connection waiting on the operation panel.

Moreover, in the image reading apparatus, the attachable and removable memory may have a user setting storing section to store a transmission destination e-mail address and a user identification information storing section to store a user name serving as user information; when the user identifying section identified that an user ID contained in the user information stored in the attachable and removable memory is coincident with the user ID stored in the user information storing section, the interface section may read out the transmission destination e-mail address and the user name and the network control section may add the user name into the image information and may transmit the image information added the user name according to the transmission destination e-mail address.

Moreover, the image reading apparatus may further comprise a transmission information storing section to store previously an e-mail address of the image reading apparatus, wherein the network control section may add the user information and the e-mail address into the image information and may transmit the image information added the user information and the e-mail address.

Further, according to the present invention, also there is provided an image processing system including an authentication server which authenticates a user and an image reading apparatus which transmits image information read out from an image of an original document to a predetermined apparatus, wherein

the authentication server has a user information storing section which preliminarily stores user information of the user who is presumed to use the image processing system and a user information identification return section which authenticates the user on the basis of identification information that is inputted by the user who requests transmission of the image information from the image reading apparatus and the user information stored in the user information storing section and transmits a result of the authentication to the image reading apparatus; and

the image reading apparatus has a user inquiry section which transmits the user identification information that is inputted by the user who requests the transmission of the image information to the authentication server and requests the authentication result of the system user and a network control section which, when the user information identification return section authenticates the user, adds the user information of the authenticated user to the image information and transmits the resultant image information to the predetermined apparatus.

Furthermore, according to the present invention, also there is provided an image processing system including an authentication server which authenticates a user and an image transfer apparatus which prints and outputs image information received from a first apparatus and transmits the printed and outputted image information to a second apparatus, wherein

the authentication server has a user information storing section which preliminarily stores user information of the user who is presumed to use the image processing system and a user information identification return section which authenticates the user on the basis of identification information that is inputted by the user who requests transmission of the image information received from the first apparatus and the user information stored in the user information storing section and transmits a result of the authentication to the image transfer apparatus; and

the image transfer apparatus has a user inquiry section which transmits the identification information that is inputted by the user who requests the transmission of the printed and outputted image information to the authentication server and requests the authentication result of the user and a communication control section which, when the user information identification return section authenticates the user, adds the user information of the authenticated user to the image information and transmits the image information added the user information to the second apparatus.

On the basis of the user information which has previously been stored in the user information storing section and the identification information which is inputted by the user, the user identifying section authenticates the user who intends to transmit the image information to a predetermined apparatus. Therefore, such an effect that a possibility that the image information is transmitted by using the wrong user information is eliminated is obtained. Further, such an effect that what is called “impersonation” in which the malicious user intentionally transmits the image information by using the user information of the third party can be prevented is obtained.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a construction of an image reading apparatus of an embodiment 1;

FIG. 2 is an explanatory diagram of user information;

FIG. 3 is a flowchart for a user identifying process in the embodiment 1;

FIG. 4 is a flowchart for an E-mail transmitting process in the embodiment 1;

FIG. 5 is a block diagram showing a construction of an image reading apparatus of an embodiment 2;

FIG. 6 is an explanatory diagram of available-user information;

FIG. 7 is a flowchart for a user identifying process in the embodiment 2;

FIG. 8 is a flowchart for a USB memory extracting process in the embodiment 2;

FIG. 9 is a block diagram showing a construction of a modification of the embodiment 2;

FIG. 10 is a flowchart for a user identifying process in the modification of the embodiment 2;

FIG. 11 is a flowchart for an E-mail transmitting process in the modification of the embodiment 2;

FIG. 12 is a block diagram showing a construction of an image processing system of an embodiment 3;

FIG. 13 is a flowchart for a user identifying process in the image processing system of the embodiment 3;

FIG. 14 is a block diagram showing a construction of an image processing system of an embodiment 4;

FIG. 15 is a flowchart for a user identifying process in the image processing system of the embodiment 4; and

FIG. 16 is a flowchart for an E-mail transmitting process in the embodiment 4.

### DETAILED DESCRIPTION OF THE PREFERRED EMBODIMENTS

### Embodiment 1

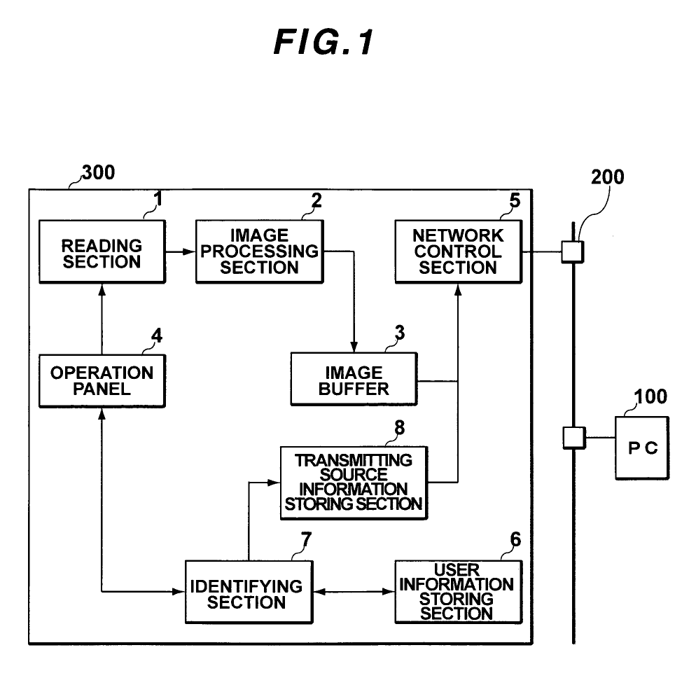

FIG. 1 is a block diagram showing a construction of an image reading apparatus of an embodiment 1.

As shown in the diagram, an image reading apparatus 300 in the embodiment 1 has: a reading section 1; an image processing section 2; an image buffer 3; an operation panel 4; a network control section 5; a user information storing section 6; an identifying section 7; and a transmitting source information storing section 8.

The reading section 1 is an image scanner for obtaining image information from an image of an original document. The image processing section 2 is a portion for receiving an output signal of the image scanner and converting it into digital image data. The image buffer 3 is a memory for receiving the digital image data from the image processing section 2 and storing it.

The operation panel 4 is an operation board for displaying the operation of the whole apparatus, settings, messages, and the like to the user. Further, the operation panel is used for the user to input a user ID which is used for identification of himself. The operation panel 4 is a portion for bearing its share of a man-machine interface between the user and the image reading apparatus 300.

The network control section 5 is a portion for constructing an image information packet by adding the user name, E-mail address, and the like which have temporarily been stored in the transmitting source information storing section 8 to the image data stored in the image buffer 3 and transmitting such a packet to a PC 100. This portion is a portion displayed as a block showing a computer control function of the image reading apparatus 300 which is formed when a CPU (not shown) activates and executes a predetermined control program which has previously been stored in a ROM (not shown). This portion further has a circuit board having a network interface (I/F) function for communication-connecting the image reading apparatus 300 to a network 200 on the basis of a predetermined protocol.

The user information storing section 6 is a memory for preliminarily storing predetermined user information which is necessary to identify whether or not the user who intends to use the image reading apparatus 300 is a user whose has preliminarily been permitted to use it.

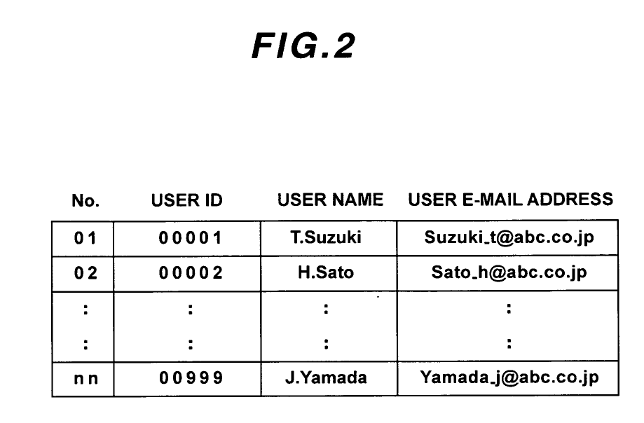

FIG. 2 is an explanatory diagram of the user information.

It is a diagram showing an example of the user information. As shown in the diagram, in the user information, serial numbers “01” to “nn” are stored in the leftmost column and, further, the user information of the user, for example, a user ID, a user name, a user E-mail address, and the like are stored in each row of each serial number.

Returning to FIG. 1, the identifying section 7 is a portion for executing user authentication by comparing the user ID inputted from the operation panel 4 with the user ID stored in the user information storing section 6. Further, if the user could be authenticated, the identifying section 7 reads out the relevant user information from the user information storing section 6 and temporarily stores it into the transmitting source information storing section 8. This portion is a portion displayed as a block showing the computer control function of the image reading apparatus 300 which is formed when the CPU (not shown) activates and executes the predetermined control program which has previously been stored in the ROM (not shown).

The transmitting source information storing section 8 is a memory for preliminarily storing an address serving as a transmitting source of the packet when the network control section 5 constructs the packet to be transmitted by E-mail to the PC 100 by using the image data stored in the image buffer 3, that is, an E-mail address that is peculiar to the image reading apparatus 300. Further, the transmitting source information storing section 8 is the memory for temporarily storing the user information received from the identifying section 7.

The operation of the image reading apparatus 300 in the embodiment 1 described above will now be explained with reference to flowcharts. First, the authenticating operation of the user who requests use of the image reading apparatus 300 will be described. Subsequently, the operation to transmit a predetermined packet (image information) by E-mail from the image reading apparatus 300 to the PC 100 through the network 200 will be explained.

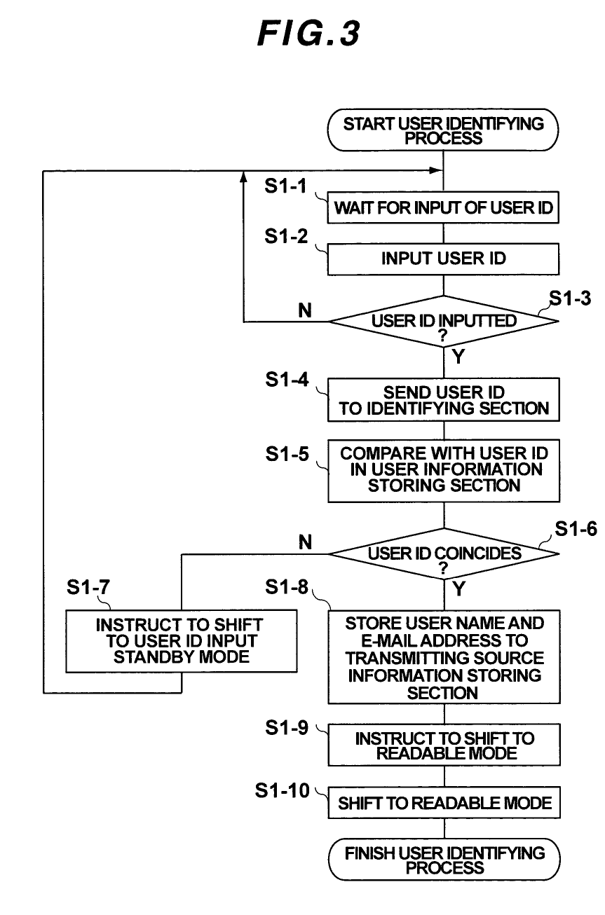

FIG. 3 is the flowchart for the user identifying process in the embodiment 1.

The operation of the user identifying process will be described hereinbelow in order from step S1-1 to step S1-10 shown in FIG. 3.

Step S1-1:

The image reading apparatus 300 (FIG. 1) is in a standby mode for waiting until the user who requests the use of the image reading apparatus 300 (FIG. 1) inputs his own user ID. At this time, a message showing the waiting for the input of the user ID is displayed on the operation panel 4 (FIG. 1).

Step S1-2:

The user who requests the use of the image reading apparatus 300 (FIG. 1) inputs his own user ID to the operation panel 4 (FIG. 1).

Step S1-3:

When the user who requests the use of the image reading apparatus 300 (FIG. 1) completes the input of his own user ID to the operation panel 4 (FIG. 1), step S1-4 follows. The standby mode is held until the completion of the input.

Step S1-4:

The inputted user ID is sent from the operation panel 4 (FIG. 1) to the identifying section 7 (FIG. 1).

Step S1-5:

The identifying section 7 (FIG. 1) searches the user information storing section 6 (FIG. 1) and collates (compares) the user ID stored in the user information storing section 6 (FIG. 1) with the inputted user ID.

Step S1-6:

When the inputted user ID does not coincide with the stored user ID (when the user cannot be authenticated), step S1-7 follows. When they coincide (when the user can be authenticated), step S1-8 follows.

Step S1-7:

The identifying section 7 (FIG. 1) sends an authentication failure notification to the operation panel 4 (FIG. 1) and a message showing the waiting for the input of the user ID is displayed on the panel, thereby allowing the apparatus to be returned to the standby mode.

Step S1-8:

The identifying section 7 (FIG. 1) reads out the user information (user name, E-mail address) stored in the user information storing section 6 (FIG. 1) and the user information is temporarily stored into the transmitting source information storing section 8 (FIG. 1).

Step S1-9:

The identifying section 7 (FIG. 1) sends a reading possible notification to the operation panel 4 (FIG. 1) so as to notify that the reading of the image information is enabled.

Step S1-10:

When the operation panel 4 (FIG. 1) receives the reading possible notification from the identifying section 7 (FIG. 1), it displays a message showing that the reading is possible, and the processing routine is finished.

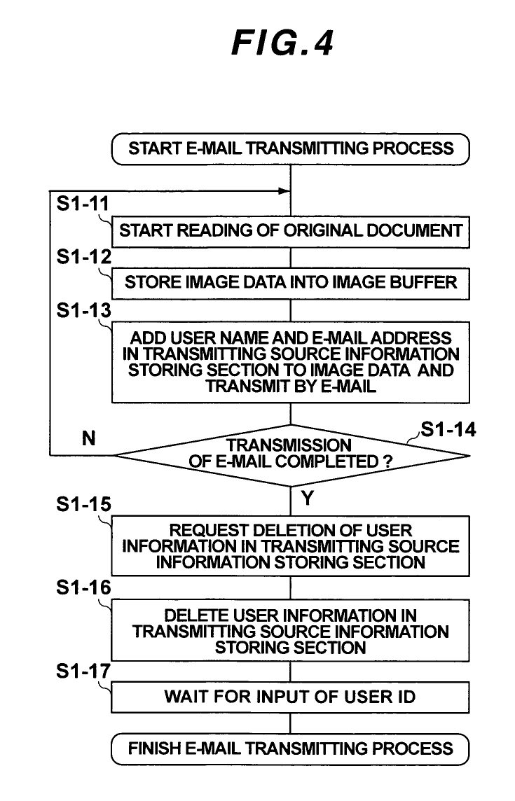

FIG. 4 is the flowchart for the E-mail transmitting process in the embodiment 1.

The operation of the E-mail transmitting process will be described hereinbelow in order from step S1-11 to step S1-17 shown in FIG. 4.

Step S1-11:

The user sets the image of the original document into the reading section 1 (FIG. 1), makes the setting regarding the E-mail transmission, inputs a transmission destination, and starts the reading of the image of the original.

Step S1-12:

The reading section 1 (FIG. 1) reads the image information from the original image and sends it to the image processing section 2. The image processing section 2 converts the image information into the image data, sends it to the image buffer 3 (FIG. 1), and allows it to be stored therein.

Step S1-13:

The network control section 5 (FIG. 1) forms the image information packet obtained by adding the user name and the E-mail address stored in the transmitting source information storing section 8 (FIG. 1) to the image data stored in the image buffer 3 (FIG. 1) and transmits the packet to the PC 100 (FIG. 1) through the network 200 (FIG. 1).

Step S1-14:

The processes of steps S1-11 to S1-14 are repeated until the transmission of the image information packet is completed. After completion of the transmission, step S11-15 follows.

Step S1-15:

When the transmission of the image information packet is completed, the operation panel 4 (FIG. 1) sends a user information deletion request notification to the identifying section 7 (FIG. 1).

Step S1-16:

When the user information deletion request notification is received, the identifying section 7 (FIG. 1) allows the user information which has temporarily been stored to be deleted from the transmitting source information storing section 8 (FIG. 1).

Step S1-17:

When the user information which has temporarily been stored is deleted from the transmitting source information storing section 8 (FIG. 1), the identifying section 7 (FIG. 1) sends a user information deletion completion notification to the operation panel 4 (FIG. 1). When the user information deletion completion notification is received, the operation panel 4 (FIG. 1) displays the message showing the waiting for the input of the user ID and is returned to the standby mode. The processing routine is finished.

As described above, according to the embodiment, the identifying section 7 (FIG. 1) compares the user ID which has previously been stored in the user information storing section 6 (FIG. 1) with the user ID which is inputted by the user to the operation panel 4 (FIG. 1), thereby authenticating the user who intends to transmit the image information to the PC 100 (FIG. 1). Therefore, there is obtained an effect of eliminating a possibility that the image information is transmitted by using the wrong user information. Further, there is obtained such an effect that what is called “impersonation” in which the malicious user intentionally transmits the image information by using the user information of the third party can be also prevented.

### Embodiment 2

It is an object of the embodiment 2 that by providing a USB memory to preliminarily store the user information and detachably providing the user information to the image reading apparatus through the USB memory, the user authentication is easily executed and, further, a possibility that a user ID is known to the third party during the inputting operation of the user ID is eliminated.

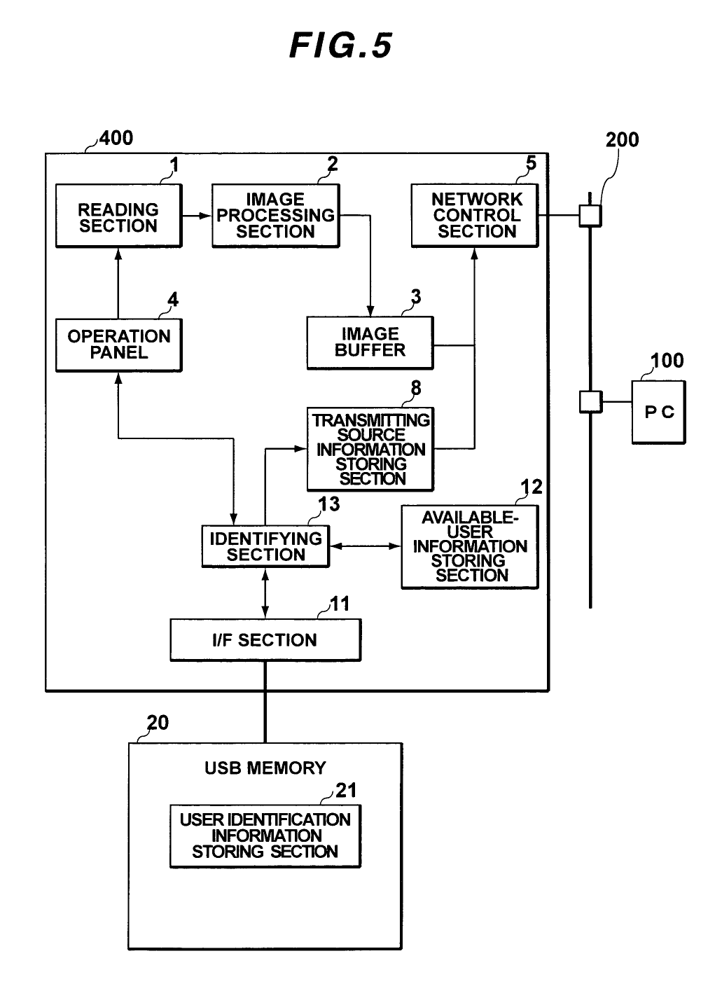

FIG. 5 is a block diagram showing a construction of an image reading apparatus of an embodiment 2.

As shown in the diagram, an image reading apparatus 400 in the embodiment 2 has: the reading section 1; the image processing section 2; the image buffer 3; the operation panel 4; the network control section 5; the transmitting source information storing section 8; an interface section (I/F section) 11; an available-user information storing section 12; an identifying section 13; and a USB memory 20. Only portions different from those in the embodiment 1 will be described hereinbelow. Portions similar to those in the embodiment 1 are designated by the same reference numerals as those in the embodiment 1 and their explanation is omitted.

The I/F section 11 is a circuit board which is connected to the USB memory 20 and has an interface function of communication-connecting the USB memory 20 to the image reading apparatus 400 in order to transmit and receive data to/from a user identification (ID) information storing section 21 provided in the USB memory 20.

The available-user information storing section 12 is a memory in which the user IDs of the users who were permitted to use the image reading apparatus 400 have preliminarily been registered.

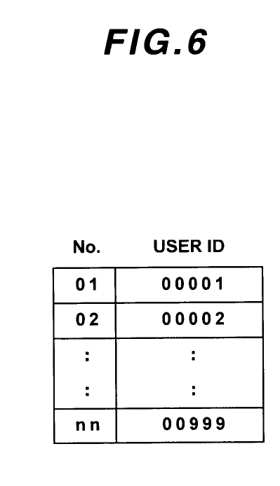

FIG. 6 is an explanatory diagram of available-user information.

This diagram shows an example of the available-user information. As shown in the diagram, in the user information, serial numbers “01” to “nn” are stored in the leftmost column and, further, the user IDs of the users who were permitted to use the image reading apparatus 400 are stored in each row of each serial number. This portion is managed by the administrator of the image reading apparatus 400 and the editing operation is guarded by an administrator ID and a password in order to inhibit the rewriting of the user information which is executed by the general users.

The identifying section 13 is a portion for making the user authentication by comparing the user ID read out of the USB memory 20 with the user ID registered in the available-user information storing section 12, thereby discriminating whether or not the image reading apparatus 400 can be used. If it is determined that the image reading apparatus 400 can be used, the identifying section 13 allows a user name and an E-mail address registered in the USB memory 20 to be temporarily stored into a transmitting source information storing section. This portion is a portion displayed as a block showing a computer control function of the image reading apparatus 400 which is formed when the CPU (not shown) activates and executes the predetermined control program which has previously been stored in the ROM (not shown).

The USB memory 20 has the user ID information storing section 21 therein and is a portion for detachably providing the user information stored in the user ID information storing section 21 to the image reading apparatus 400. Since the contents of the user information stored in the user ID information storing section 21 are substantially the same as those already described above, their explanation is omitted here.

The operation of the image reading apparatus 400 in the embodiment 2 described above will now be explained with reference to flowcharts. First, the authenticating operation of the user who requests use of the image reading apparatus 400 will be described. Subsequently, the operation to take out the USB memory 20 from the image reading apparatus 400 will be described.

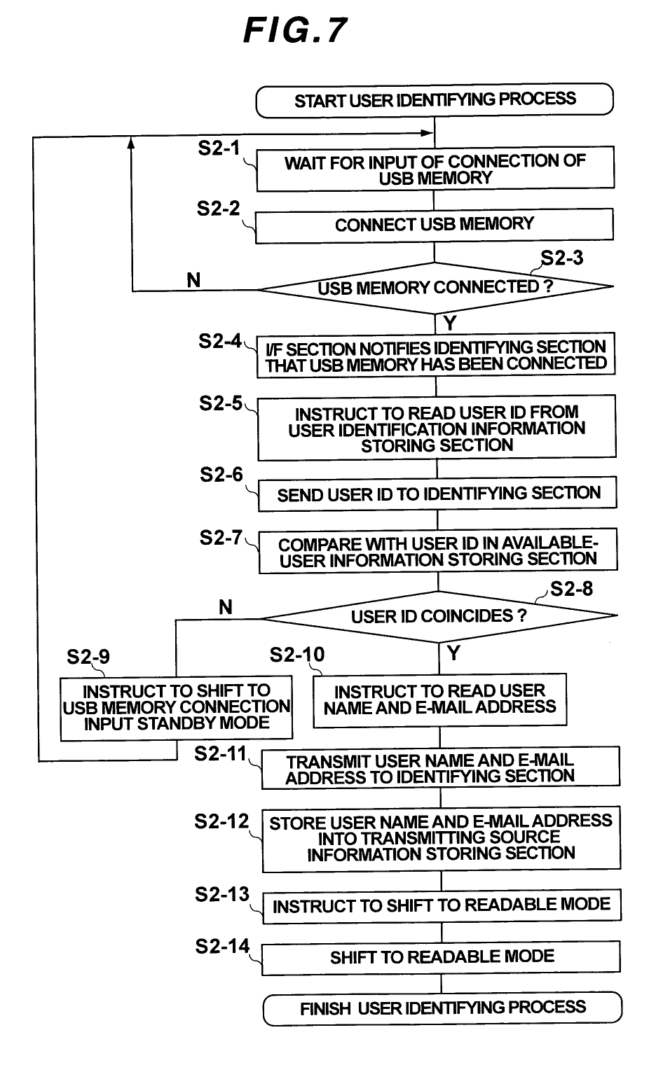

FIG. 7 is the flowchart for the user identifying process in the embodiment 2.

The operation for the user identifying process will be explained hereinbelow in order from step S2-1 to step S2-14 shown in FIG. 7.

Step S2-1:

The image reading apparatus 400 (FIG. 5) is in a standby mode for waiting until the user who requests the use of the image reading apparatus 400 (FIG. 5) connects the USB memory 20 (FIG. 5) to the image reading apparatus 400 and inputs his own user ID. A message showing the waiting for the connection of the USB memory 20 is displayed on the operation panel 4 (FIG. 5).

Step S2-2:

The user who requests the use of the image reading apparatus 400 (FIG. 5) connects the USB memory 20 (FIG. 5) to the I/F section 11 (FIG. 5).

Step S2-3:

The I/F section 11 (FIG. 5) monitors the connection/non-connection of the USB memory 20 (FIG. 5). Until the connection of the USB memory 20 (FIG. 5) to the I/F section 11 (FIG. 5) is completed, the standby mode is held. Step S2-4:

When the connection of the USB memory 20 (FIG. 5) to the I/F section 11 (FIG. 5) is completed, the I/F section 11 (FIG. 5) sends a connection completion notification to the identifying section 13.

Step S2-5:

The identifying section 13 (FIG. 5) sends a user ID obtaining request notification for requesting the obtainment of the user ID from the user ID information storing section 21 to the I/F section 11 (FIG. 5).

Step S2-6:

The I/F section 11 (FIG. 5) reads out the user ID from the user ID information storing section 21 and sends it to the identifying section 13 (FIG. 5).

Step S2-7:

The identifying section 13 (FIG. 5) searches the available-user information storing section 12 (FIG. 5) and collates (compares) the user ID stored in the available-user information storing section 12 (FIG. 5) with the obtained user ID.

Step S2-8:

If the obtained user ID does no coincide with the stored user ID (when the user cannot be authenticated), step S2-9 follows. If they coincide (when the user can be authenticated), step S2-10 follows.

Step S2-9:

The identifying section 13 (FIG. 5) sends an authentication failure notification to the operation panel 4 (FIG. 5), a message showing the waiting for the connection of the USB memory 20 is displayed on the operation panel 4 (FIG. 5), and the apparatus is returned to the standby mode.

That is, the identifying section 13, when identified that an user ID contained in the user information stored in the attachable and removable memory is different from the user ID stored in the user information storing section, transmits an identification failure notification and executes a display of a message indicating the identification failure notification and a memory connection waiting on the operation panel.

Step S2-10:

The identifying section 13 (FIG. 5) sends a user information reading request notification to the I/F section 11 (FIG. 5) and instructs to read the user information (user name, E-mail address) stored in the user ID information storing section 21 (FIG. 5).

Step S2-11:

The I/F section 11 (FIG. 5) reads out the user information (user name, E-mail address) from the user ID information storing section 21 (FIG. 5) and sends it to the identifying section 13 (FIG. 5).

Step S2-12:

The identifying section 13 (FIG. 5) sends the user information (user name, E-mail address) to the transmitting source information storing section 8 (FIG. 5) and allows it to be temporarily stored therein.

Step S2-13:

The identifying section 13 (FIG. 5) sends the reading possible notification for notifying that the reading of the image information is possible to the operation panel 4 (FIG. 5).

Step S2-14:

When the reading possible notification is received from the identifying section 13 (FIG. 5), the operation panel 4 (FIG. 5) displays a message showing that the reading is possible. The processing routine is finished. Thus, persons other than the users who were permitted by the administrator to use the image reading apparatus 400 (FIG. 5) and have preliminarily been registered in the available-user information storing section 12 (FIG. 5) cannot use the image reading apparatus 400 (FIG. 5). Since the E-mail transmitting process in the embodiment is similar to that in the embodiment 1 (FIG. 4), its explanation is omitted here.

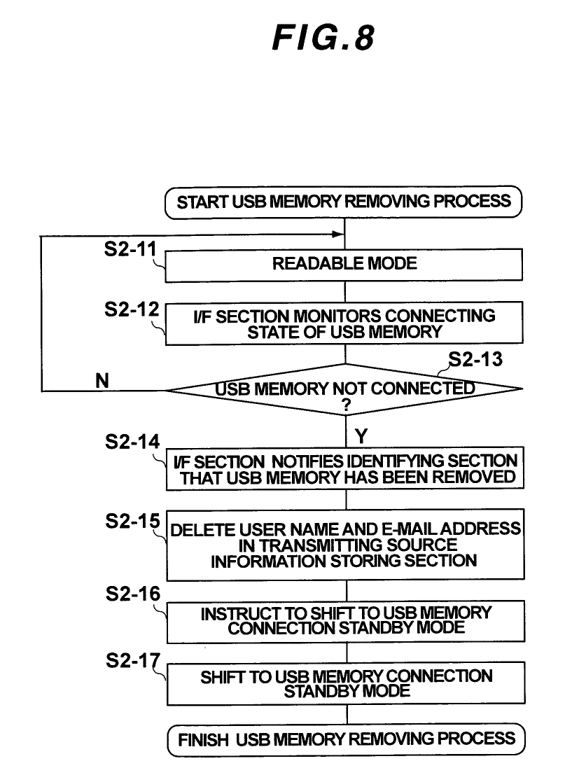

FIG. 8 is the flowchart for the USB memory extracting process in the embodiment 2.

The operation for the USB memory extracting process will be explained hereinbelow in order from step S2-11 to step S2-17 shown in FIG. 8.

Step S2-11:

The image reading apparatus 400 (FIG. 5) maintains the reading possible state.

Step S2-12:

The I/F section 11 (FIG. 5) monitors the connection/non-connection of the USB memory 20 (FIG. 5).

Step S2-13:

When the I/F section 11 (FIG. 5) detects the non-connection of the USB memory 20 (FIG. 5), step S2-14 follows. While the connection is detected, the I/F section 11 (FIG. 5) continues the monitoring operation.

Step S2-14:

When the non-connecting state (disconnecting state) of the USB memory 20 (FIG. 5) is detected, the I/F section 11 (FIG. 5) sends a non-connection notification to the identifying section 13 (FIG. 5) and notifies that the USB memory 20 (FIG. 5) has been extracted.

Step S2-15:

When the non-connection notification is received, the identifying section 13 (FIG. 5) deletes the user information (user name, E-mail address) stored in the transmitting source information storing section 8 (FIG. 5).

Step S2-16:

The identifying section 13 (FIG. 5) sends the non-connection notification to the operation panel 4 (FIG. 5) and instructs it to shift to a connection standby mode.

Step S2-17:

When the non-connection notification is received from the identifying section 13 (FIG. 5), the operation panel 4 (FIG. 5) displays the message showing the waiting for the connection of the USB memory 20 and shifts to the connection standby mode. The processing routine is finished.

As described above, according to the embodiment 2, by providing the user ID information storing section 21 (FIG. 5) in the USB memory and detachably providing the user information stored in the user ID information storing section 21 (FIG. 5) to the image reading apparatus 400 (FIG. 5) through the USB memory, the user can be authenticated merely by connecting the USB memory to the image reading apparatus 400 (FIG. 5). Therefore, such an effect that the possibility that the user ID is known to the third party during the inputting operation of the user ID is eliminated is obtained. In the embodiment, since the administrator stores and manages the available-user information storing section 12 (FIG. 5), even if the user freely inputted the user information into the user ID information storing section 21 (FIG. 5), use of the image reading apparatus 400 (FIG. 5) is not permitted.

A modification of the foregoing embodiment 2 will be described hereinbelow.

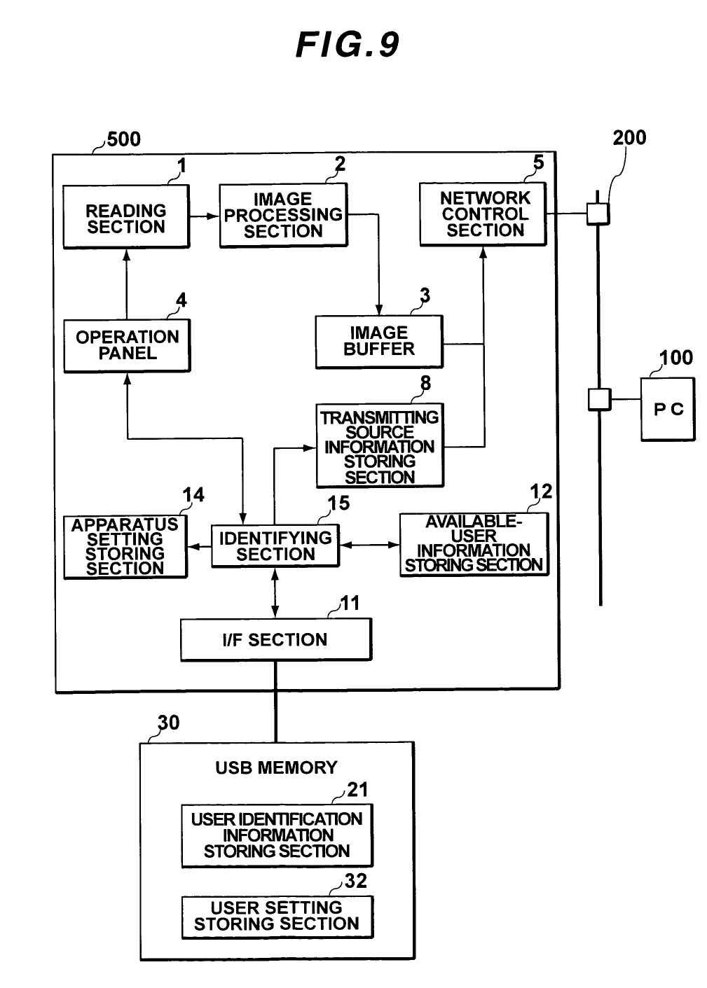

FIG. 9 is a block diagram showing a construction of the modification of the embodiment 2.

As shown in the diagram, an image reading apparatus 500 in the modification of the embodiment 2 has: the reading section 1; the image processing section 2; the image buffer 3; the operation panel 4; the network control section 5; the transmitting source information storing section 8; the I/F section 11; the available-user information storing section 12; an apparatus setting storing section 14; an identifying section 15; and a USB memory 30. Only portions different from those in the embodiment 2 will be described hereinbelow. Portions similar to those in the embodiment 1 or 2 are designated by the same reference numerals as those in the embodiment 1 or 2 and their explanation is omitted.

The apparatus setting storing section 14 is a memory for storing apparatus settings and a transmission destination E-mail address of each user obtained by the identifying section 15 from the USB memory 30.

The identifying section 15 is a portion for making the user authentication by collating the user ID read out of the USB memory 30 with the user ID registered in the available-user information storing section 12, thereby discriminating whether or not the image reading apparatus 500 can be used. If it is determined that the image reading apparatus 500 can be used, the identifying section 15 allows a user name and an E-mail address registered in the USB memory 30 to be temporarily stored into the transmitting source information storing section. Further, in the modification, the identifying section 15 is a portion for storing the apparatus settings and the transmission destination E-mail address of the user read out of the USB memory 30 to the apparatus setting storing section 14. This portion is a portion displayed as a block showing a computer control function of the image reading apparatus 600 which is formed when the CPU (not shown) activates and executes the predetermined control program which has previously been stored in the ROM (not shown).

The USB memory 30 has the user ID information storing section 21 and a user setting storing section 32 therein and is a portion for detachably providing the user information stored in the user ID information storing section 21 and the apparatus settings and the transmission destination E-mail address of the user stored in the user setting storing section 32 to the image reading apparatus 500. Since the contents of the user information stored in the user ID information storing section 21 are substantially the same as those in FIG. 2 which have already been described above, their explanation is omitted here. The apparatus settings of the user stored in the user setting storing section 32 are initial set values which are used when the user of the USB memory 30 uses the image reading apparatus 500.

The operation of the image reading apparatus 500 in the modification of the embodiment 2 described above will now be explained with reference to flowcharts. First, the authenticating operation of the user who requests use of the image reading apparatus 500 will be described. Subsequently, the operation to transmit a predetermined packet (image information) by E-mail from the image reading apparatus 500 to the PC 100 through the network 200 will be described.

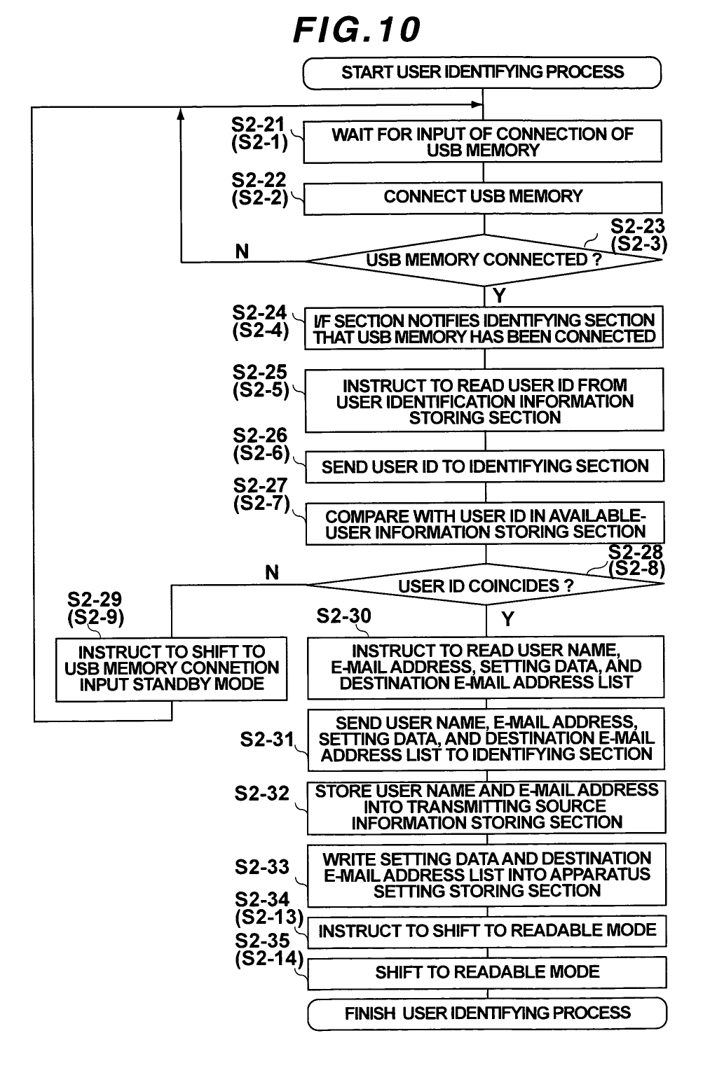

FIG. 10 is the flowchart for the user identifying process in the modification of the embodiment 2.

The operation for the user identifying process will be explained hereinbelow in order from step S2-21 to step S2-35 shown in FIG. 10. Only processes different from those in the embodiment 2 will be explained. Processes similar to those in the embodiment 2 are designated by the same processing step numbers as those in the embodiment 2 and their explanation is omitted here. Since steps S2-21 to S2-29 are similar to steps S2-1 to S2-9 in the embodiment 2 and steps S2-34 and S2-35 are similar to steps S2-13 and S2-14, processes of steps S2-30 to S2-33 will be explained.

Step S2-30:

The identifying section 15 (FIG. 9) sends a user information reading request notification to the I/F section 11 (FIG. 9) and instructs the reading of the user information (user name, E-mail address) stored in the user ID information storing section 21 (FIG. 9). Further, the identifying section 15 (FIG. 9) sends a user setting information reading request notification to the I/F section 11 (FIG. 9) and instructs the reading of the set values and the transmission destination E-mail address.

Step S2-31:

The I/F section 11 (FIG. 9) reads out the user information (user name, E-mail address) from the user ID information storing section 21 (FIG. 9) and sends it to the identifying section 15 (FIG. 9). Further, the I/F section 11 (FIG. 9) reads out the set values and the transmission destination E-mail address from the user setting storing section 32 (FIG. 9) and sends them to the identifying section 15 (FIG. 9).

Step S2-32:

The identifying section 15 (FIG. 9) sends the user information (user name, E-mail address) to the transmitting source information storing section 8 (FIG. 9) so as to be temporarily stored therein.

Step S2-33:

The identifying section 15 (FIG. 9) sends the set values and the transmission destination E-mail address to the apparatus setting storing section 14 (FIG. 9) so as to be temporarily stored.

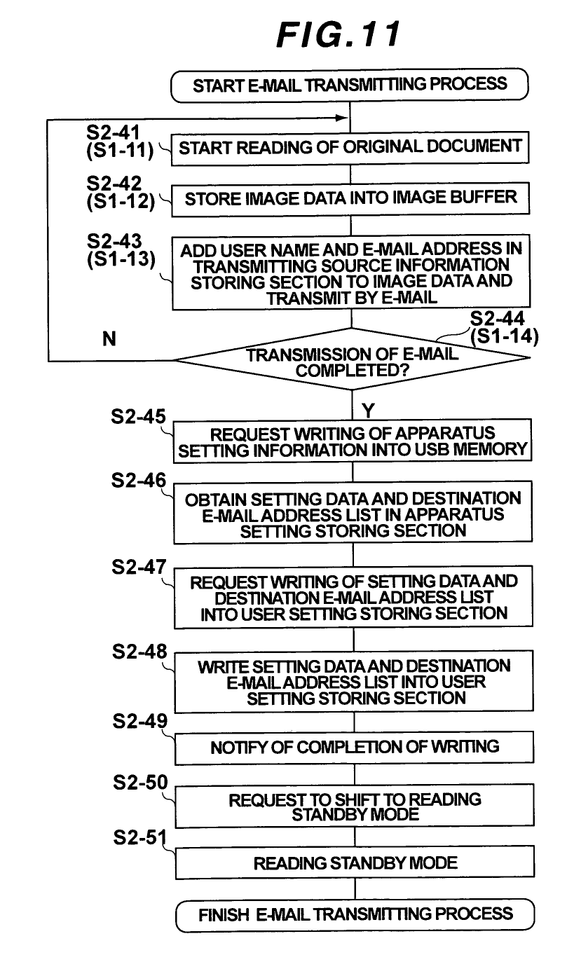

FIG. 11 is a flowchart for an E-mail transmitting process in the modification of the embodiment 2.

The operation for the E-mail transmitting process will be described hereinbelow in order of steps S2-41 to S2-51 shown in FIG. 11.

Processes similar to those in the embodiment 1 (this is true of the embodiment 2) are designated by the same processing step numbers as those in the embodiment 1 and their explanation is omitted here. Since steps S2-41 to S2-44 are similar to steps S1-11 to S1-14 in the embodiment 1, processes of step S2-45 and subsequent steps will be explained.

Step S2-45:

After completion of the E-mail transmission of the image of the original set to the reading section 1 (FIG. 9), the operation panel 4 (FIG. 9) sends a user setting information writing request notification to the identifying section 15 (FIG. 9).

Step S2-46:

When the user setting information writing request notification is received, the identifying section 15 (FIG. 9) obtains user setting information (set values, transmission destination E-mail address) from the apparatus setting storing section 14 (FIG. 9).

Step S2-47:

The identifying section 15 (FIG. 9) sends the user setting information (set values, transmission destination E-mail address) to the I/F section 11 (FIG. 9) and requests the writing into the user setting storing section 32 (FIG. 9).

Step S2-48:

The I/F section 11 (FIG. 9) writes the user setting information (set values, transmission destination E-mail address) into the user setting storing section 32 (FIG. 9).

Step S2-49:

After completion of the writing of the user setting information (set values, transmission destination E-mail address) into the user setting storing section 32 (FIG. 9), the I/F section 11 (FIG. 9) sends a writing completion notification to the identifying section 15 (FIG. 9).

Step S2-50:

The identifying section 15 (FIG. 9) sends the reading possible notification for notifying that the reading of the image information is possible to the operation panel 4 (FIG. 9).

Step S2-51:

When the reading possible notification is received from the identifying section 15 (FIG. 9), the operation panel 4 (FIG. 9) displays a message showing that the reading is possible. The processing routine is finished.

As described above, according to the modification of the embodiment 2, the user setting storing section 32 (FIG. 9) is provided for the USB memory 30 (FIG. 9) and private management can be made by using the user setting information (set values, transmission destination E-mail address) which has been set by each user besides the user name and the E-mail address of the user serving as a transmitting source. Therefore, such an effect that there is no need to store the E-mail address or the like which the user does not want that it is known to the third party into the image reading apparatus 500 is obtained.

### Embodiment 3

Although the authentication of the user who desires to use the image reading apparatus has been made in the image reading apparatus in the foregoing embodiments 1 and 2, in the embodiment 3, the user authentication is made in an authentication server newly provided in the embodiment. That is, it is assumed that the user authentication is made by an image processing system instead of the sole image reading apparatus. This is because the reliability is further improved by making the user authentication by another division different from the image reading apparatus.

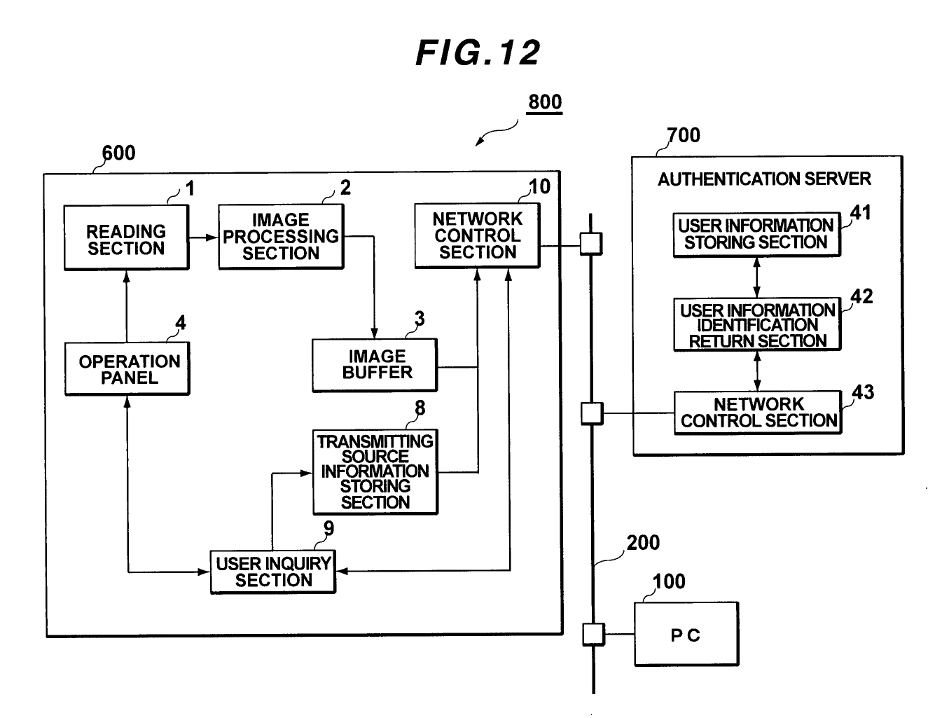

FIG. 12 is a block diagram showing a construction of the image processing system of the embodiment 3.

As shown in the diagram, an image processing system 800 of the embodiment 3 is constructed by mutually connecting an image reading apparatus 600, an authentication server 700, and the PC 100 through the network 200. Constructing portions will be described in detail hereinbelow.

On the basis of a request of the user who was permitted to use the image reading apparatus 600, the image reading apparatus 600 is an apparatus for obtaining the image information from the original image, converting it into digital image data, forming an image information packet to which predetermined information has been added, and transmitting the packet to the PC 100 through the network 200. The inside of the image reading apparatus 600 is constructed as follows.

The image reading apparatus 600 has: the reading section 1; the image processing section 2; the image buffer 3; the operation panel 4; the transmitting source information storing section 8; a user inquiry section 9; and a network control section 10. Only portions different from those of the image reading apparatus 300 in the embodiment 1 will be described hereinbelow. Portions similar to those of in the embodiment 1 are designated by the same reference numerals as those in the embodiment 1 and their explanation is omitted.

When the user ID of the user who requests use of the image reading apparatus 600 is received through the operation panel 4, the user inquiry section 9 sends a user information obtaining request notification for requesting the authentication of the user and the obtainment of the user information to the network control section 10. At this time, when a connection non-permission notification showing that the connection to the authentication server 700 is not permitted is received from the network control section 10, the user inquiry section 9 returns the operation panel 4 into the user ID input standby mode. When an authentication failure notification is received from the network control section 10, the user inquiry section 9 returns the operation panel 4 into the user ID input standby mode. When the authentication result indicates a success, the user inquiry section 9 receives the user information (user name, E-mail address, etc.) so as to be temporarily stored into the transmitting source information storing section 8. This portion is a portion displayed as a block showing the computer control function of the image reading apparatus 600 which is formed when the CPU (not shown) activates and executes the predetermined control program which has previously been stored in the ROM (not shown).

The network control section 10 is a portion for constructing the image information packet by adding the user name, E-mail address, and the like which have temporarily been stored in the transmitting source information storing section 8 to the image data stored in the image buffer 3 and transmitting such a packet to the PC 100. In the embodiment 3, particularly, when the user information obtaining request notification is received from the user inquiry section 9, the network control section 10 forms a user information obtaining request signal including the user ID, the ID of the image reading apparatus, and the password and transmits such a signal to the authentication server 700. The ID of the image reading apparatus and the password become discrimination target information about the connection permission/non-permission to the image reading apparatus 600 upon discrimination which is made by the authentication server 700. When a connection non-permission signal is received from the authentication server 700, the network control section 10 sends the connection non-permission notification to the user inquiry section 9. When an authentication failure notification signal is received from the authentication server 700, the network control section 10 sends the authentication failure notification signal to the user inquiry section 9. Further, when the authentication is successful, the network control section 10 receives the user information and sends it to the user inquiry section 9. This portion is a portion displayed as a block showing the computer control function of the image reading apparatus 600 which is formed when the CPU (not shown) activates and executes the predetermined control program which has previously been stored in the ROM (not shown). Further, this portion has a circuit board having a network interface function for communication-connecting the image reading apparatus 600 to the network 200 on the basis of a predetermined protocol.

The authentication server 700 has therein a user information storing section 41, a user information identification return section 42, and a network control section 43. When the user information obtaining request signal is received from the image reading apparatus 600 through the network 200, the authentication server 700 discriminates the connection permission/non-permission to the image reading apparatus 600 on the basis of the ID, password, and the like of the image reading apparatus included in such a signal. The authentication server 700 is a server apparatus constructed in such a manner that if it is determined that the connection is not permitted, the connection non-permission signal is sent to the image reading apparatus 600, if it is determined that the connection is permitted, the user authentication is made on the basis of the user ID, if the authentication failed, the authentication failure notification signal is sent to the image reading apparatus 600, and if the authentication is successful, the user information is returned to the image reading apparatus 600 through the network 200.

The user information storing section 41 is a memory for previously storing the user information of the user who is presumed to use the image reading apparatus 600. Since the contents of the user information are substantially the same as those described in FIG. 2, their explanation is omitted here.

The user information identification return section 42 is a portion constructed as follows. When the user information obtaining request notification is received from the network control section 43, the connection permission/non-permission to the image reading apparatus 600 is discriminated from the ID, password, and the like of the image reading apparatus 600 included in the signal. If it is determined that the connection is not permitted, the connection non-permission notification is sent to the network control section 43. If it is determined that the connection is permitted, the inputted user ID is collated with the user ID stored in the user information storing section 41, thereby making the user authentication. If the authentication failed, the authentication failure notification is sent to the network control section 43. If the authentication is successful, the corresponding user information is read out of the user information storing section 41 and sent to the network control section 43. This portion is a portion displayed as a block showing a computer control function of the authentication server 700 which is formed when the CPU (not shown) activates and executes the predetermined control program which has previously been stored in the ROM (not shown).

When the user information obtaining request signal is received from the image reading apparatus 600 through the network 200, the network control section 43 sends the user information obtaining request notification to the user information identification return section 42. When the connection non-permission notification is received from the user information identification return section 42, the network control section 43 transmits the connection non-permission signal to the image reading apparatus 600. Further, when the authentication failure notification is received, the network control section 43 transmits the authentication failure notification signal to the image reading apparatus 600. When the user information is received, the network control section 43 transmits the user information signal to the image reading apparatus 600. This portion is a portion displayed as a block showing the computer control function of the authentication server 700 which is formed when the CPU (not shown) activates and executes the predetermined control program which has previously been stored in the ROM (not shown). Further, this portion has a circuit board having a network interface function for communication-connecting the authentication server 700 to the network 200 on the basis of a predetermined protocol.

The PC 100 is a terminal apparatus for receiving, from the image reading apparatus 600 through the network 200, the E-mail signal (image information packet) formed while including the image information which has been read out from the original image by the image reading apparatus 600. Generally, a personal computer is used as a PC 100. The network 200 is a communication network for communication-connecting the image reading apparatus 600, authentication server 700, and PC 100 on the basis of a predetermined protocol.

The operation of the image processing system 800 of the embodiment 3 described above will now be explained with reference to flowcharts.

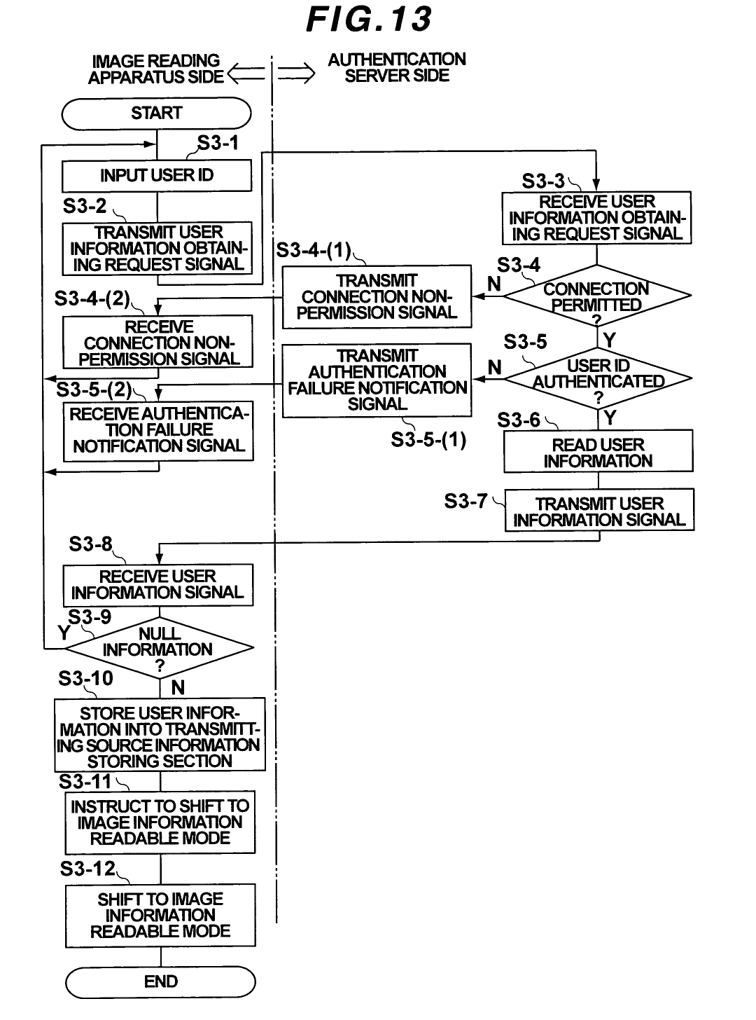

FIG. 13 is the flowchart for a user identifying process in the image processing system of the embodiment 3.

In the flowchart, a processing routine shown on the image reading apparatus side shows the operation in the image reading apparatus 600 (FIG. 12) and a processing routine shown on the authentication server side shows the operation in the authentication server 700 (FIG. 12). Communication between them is made through the network 200 (FIG. 12). The operation for the user identifying process will be described hereinbelow in order of steps S3-1 to S3-12 (which coincides with order of elapsed time) shown in FIG. 13.

Step S3-1:

The image reading apparatus 600 (FIG. 12) is in the standby mode for waiting until the user who requests use of the image reading apparatus 600 (FIG. 12) inputs his own user ID. At this time, a message showing the waiting for the input of the user ID is displayed on the operation panel 4 (FIG. 12). When the input of his own user ID to the operation panel 4 (FIG. 12) by the user is completed, step S3-2 follows. The standby mode is held until the completion of the input.

Step S3-2:

When the user ID of the user who requests the use of the image reading apparatus 600 (FIG. 12) is received through the operation panel 4 (FIG. 12), the user inquiry section 9 (FIG. 12) sends the user information obtaining request notification for requesting the user authentication and the obtainment of the user information to the network control section 10 (FIG. 12). When the user information obtaining request notification is received from the user inquiry section 9 (FIG. 12), the network control section 10 (FIG. 12) forms the user information obtaining request signal including the user ID, the ID of the image reading apparatus 600 (FIG. 12), and the password and transmits such a signal to the authentication server 700 (FIG. 12) through the network 200 (FIG. 12).

Step S3-3:

When the user information obtaining request signal is received through the network 200 (FIG. 12), the network control section 43 (FIG. 12) transmits the user information obtaining request notification to the user information identification return section 42 (FIG. 12).

Step S3-4:

When the user information obtaining request notification is received from the network control section 43 (FIG. 12), the user information identification return section 42 (FIG. 12) discriminates the connection permission/non-permission from the ID, password, and the like of the image reading apparatus 600 (FIG. 12) included in the signal. If it is determined that the connection is permitted, step S3-5 follows. If it is determined that the connection is not permitted, step S3-4-(1) follows.

Step S3-4-(1):

When the user information identification return section 42 (FIG. 12) sends the non-permission notification to the network control section 43 (FIG. 12), the network control section 43 (FIG. 12) forms the connection non-permission signal and transmits it to the image reading apparatus 600 (FIG. 12) through the network 200 (FIG. 12).

Step S3-4-(2):

When the connection non-permission signal is received, the network control section 10 (FIG. 12) is returned to step S3-1 and allows the operation panel 4 (FIG. 12) to be returned to the standby mode for waiting for the user ID input.

Step S3-5:

The user information identification return section 42 (FIG. 12) compares the inputted user ID with the user ID stored in the user information storing section 41 (FIG. 12), thereby making the user authentication. If the authentication is successful, step S3-6 follows. If the authentication failed, step S3-5-(1) follows.

Step S3-5-(1):

When the user information identification return section 42 (FIG. 12) sends an authentication failure notification to the network control section 43 (FIG. 12), the network control section 43 (FIG. 12) forms an authentication failure notification signal and transmits it to the image reading apparatus 600 (FIG. 12) through the network 200 (FIG. 12).

Step S3-5-(2):

When the authentication failure notification signal is received, the network control section 10 (FIG. 12) is returned to step S3-1 and allows the operation panel 4 (FIG. 12) to be returned to the standby mode for waiting for the user ID input.

Step S3-6:

The user information identification return section 42 (FIG. 12) reads out the corresponding user information from the user information storing section 41 (FIG. 12) and sends it to the network control section 43 (FIG. 12).

Step S3-7:

The network control section 43 (FIG. 12) forms a user information signal and transmits it to the image reading apparatus 600 (FIG. 12) through the network 200 (FIG. 12).

Step S3-8:

When the user information signal is received, the network control section 10 (FIG. 12) sends the user information to the user inquiry section 9 (FIG. 12).

Step S3-9:

The user inquiry section 9 (FIG. 12) allows the user information to be displayed on the operation panel 4 (FIG. 12) and requests the user to make a check. If it is NULL information, the processing routine is returned to step S3-1 and the operation panel 4 (FIG. 12) is returned to the standby mode for waiting for the user ID input. If the user information is normal information, step S3-10 follows.

Step S3-10:

The user inquiry section 9 (FIG. 12) allows the received user information signal to be temporarily stored into the transmitting source information storing section 8 (FIG. 12).

Step S3-11:

The user inquiry section 9 (FIG. 12) sends a reading possible notification for notifying that the reading of the image information is possible to the operation panel 4 (FIG. 12).

Step S3-12:

When the reading possible notification is received from the user inquiry section 9 (FIG. 12), the operation panel 4 (FIG. 12) displays a message showing that the reading is possible. The processing routine is finished. Since other operation is similar to that of the embodiment 1, its explanation is omitted.

As described above, by making the user authentication in the authentication server 700 (FIG. 12) newly provided in the embodiment, the user authentication is made by another division different from the image reading apparatus. Therefore, since the ID of the image reading apparatus whose use has preliminarily been permitted even for the connection to the authentication server 700 (FIG. 12) and the password are checked, such an effect that the reliability of the user authentication is further improved is obtained.

It is also possible to construct in the following manner. A printing apparatus (printer) is further provided to the image reading apparatus 600 (FIG. 12) in the embodiment, the image information is read out of the original image and printed, after completion of the printing of the image information, predetermined information is added to its digital image data, and an image information packet is formed and transmitted to a predetermined storing apparatus (for example, PC 100 (FIG. 12) here) through the network 200. Or, it is also possible to construct as follows. The image information is received from another PC and printed, after completion of the printing of the image information, predetermined information is added to its digital image data, and an image information packet is again formed and transmitted to the predetermined storing apparatus through the network 200. Such an example will be explained hereinbelow.

### Embodiment 4

In the foregoing embodiments 1 to 3, it is presumed that the image reading apparatus reads the image information from the original image and sends it to a predetermined PC, and the authentication of the user who requests the use of the image reading apparatus is made. In the embodiment, it is presumed that the printer receives predetermined image information from the PC through the network (the printer itself can also read the image information from the original image), the received image is printed, and thereafter, the image information is transferred to a predetermined server (or predetermined PC). In such a case, it is necessary to authenticate the user who requests use of the printer. Such an information processing system is constructed as follows.

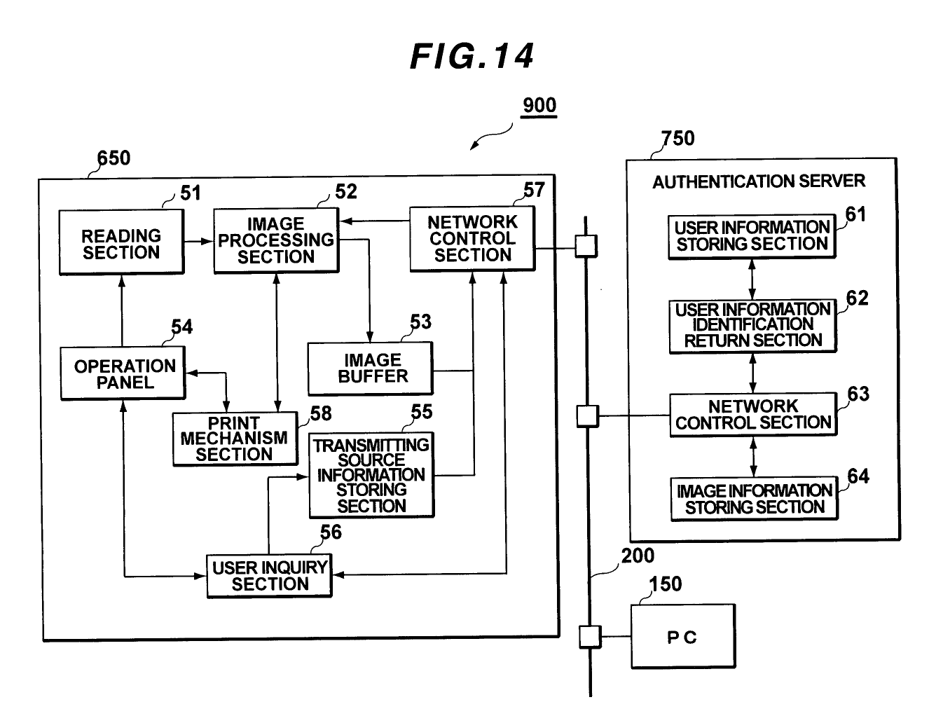

FIG. 14 is a block diagram showing a construction of an image processing system of an embodiment 4.

As shown in the diagram, an image processing system 900 in the embodiment 4 is constructed by mutually connecting an image transfer apparatus 650, an authentication server 750, and a PC 150 through the network 200. Constructing portions will be described in detail hereinbelow.

The image transfer apparatus 650 corresponds to the printer. When a user ID signal is received from the PC 150 on the basis of the request of the user who requests the use of the printer, the image transfer apparatus 650 requests the authentication server 750 to make the user authentication. If the user is authenticated, the image transfer apparatus 650 receives an image information packet from the PC 150, again forms the image information packet in which predetermined information has been added to its digital image data after completion of the printing of the image information, and transfers the packet to the authentication server 750 through the network 200. The inside of the image transfer apparatus 650 is constructed as follows.

The image transfer apparatus 650 is an image-readable printer (an example) having a reading section 51, an image processing section 52, an image buffer 53, an operation panel 54, a transmitting source information storing section 55, a user inquiry section 56, a network control section 57, and a print mechanism section 58. The image transfer apparatus 650 will be explained in detail hereinbelow.

The reading section 51 is an image scanner for obtaining the image information from the original image. The reading section 51 is a portion which is necessary in the case where the image transfer apparatus 650 according to the embodiment directly obtains the image information from the original image (not shown) and prints it. By providing the reading section 51 as mentioned above, the image transfer apparatus 650 can be also made operative as an image reading apparatus 600 (FIG. 12) in the embodiment 3.

The image processing section 52 is a portion for separating the image information packet received by the network control section 57 from the PC 150 through the network 200, forming print data, sending it to the print mechanism section 58, and allowing the print data to be stored as digital image data into the image buffer 53. The image processing section 52 is also a portion for receiving an output signal of the reading section 51, forming print data, sending it to the print mechanism section 58, and allowing the print data to be stored as digital image data into the image buffer 53.

The image buffer 53 is a memory for receiving the digital image data from the image processing section 52 and storing it.

The operation panel 54 is an operation board constructed in such a manner that in the case where the image transfer apparatus 650 according to the embodiment directly obtains the image information from the original image (not shown) and prints it, the operation of the whole apparatus, settings, messages, and the like are displayed to the user, and further, the user who uses the image transfer apparatus 650 in a manner similar to the embodiment 3 inputs the user ID which is used for his own identification. The operation panel 54 is also a portion which bears a share of the man-machine interface between the user and the image transfer apparatus 650.

The transmitting source information storing section 55 is a memory constructed in such a manner that in the case where the network control section 57 forms the image information packet which is transmitted to the authentication server 750 by using the image data stored in the image buffer 53, an address serving as a transmitting source of the packet, that is, an image transfer apparatus ID peculiar to the image transfer apparatus 650 and an E-mail address are previously stored. Further, the transmitting source information storing section 55 is a memory for temporarily storing the user information received from the user inquiry section 56.

When the user ID of the user who requests the use of the image transfer apparatus is received from the network control section 57, the user inquiry section 56 sends the user information obtaining request notification for requesting the authentication of the user and the obtainment of the user information to the network control section 57. The user inquiry section 56 is also a portion for receiving the user information (user name, E-mail address, etc.) from the network control section 57 and allows it to be temporarily stored into the transmitting source information storing section 55. This portion is a portion displayed as a block showing a computer control function of the image transfer apparatus 650 which is formed when the CPU (not shown) activates and executes the predetermined control program which has previously been stored in the ROM (not shown).

When the user information obtaining request notification is received from the user inquiry section 56, the network control section 57 forms the user information obtaining request signal including the user ID, the ID of the image transfer apparatus, and the password and transmits them to the authentication server 750. The ID of the image transfer apparatus and the password become the discrimination target information about the connection permission/non-permission to the image transfer apparatus 650 upon discrimination which is made by the authentication server 750. The network control section 57 is a portion for receiving the image information packet from the PC 150 through the network 200 and sending it to the image processing section 52. The network control section 57 is also a portion for reconstructing the image information packet by adding the user name, E-mail address, and the like which have temporarily been stored in the transmitting source information storing section 55 to the image data stored in the image buffer 53 and transmitting them to the PC 150. Further, with the authentication server 750 and the PC 150, the network control section 57 executes communication of a control signal for making the user authentication of the user who requests the use of the image transfer apparatus 650. This portion is a portion displayed as a block showing the computer control function of the image transfer apparatus 650 which is formed when the CPU (not shown) activates and executes the predetermined control program which has previously been stored in the ROM (not shown). Further, this portion has a circuit board having a network interface function for communication-connecting the image transfer apparatus 650 to the network 200 on the basis of a predetermined protocol.

The authentication server 750 has therein a user information storing section 61, a user information identification return section 62, and a network control section 63. When the user information obtaining request signal is received from the image transfer apparatus 650 through the network 200, the authentication server 750 discriminates the connection permission/non-permission to the image transfer apparatus 650 on the basis of the ID, password, and the like of the image transfer apparatus included in such a signal. If it is determined that the connection is not permitted, the authentication server 750 transmits the connection non-permission signal to the PC 150. If it is determined that the connection is permitted, the authentication server 750 makes the user authentication on the basis of the user ID. If the authentication failed, the authentication server 750 transmits the authentication failure notification signal to the PC 150. If the authentication is successful, the authentication server 750 returns the user information to the PC 150 through the network 200 so as to transfer it to the image transfer apparatus 650. Further, the authentication server 750 is a server apparatus for receiving the image information packet whose contents are the image information obtained after the end of the printing and storing the image information.

The user information storing section 61 is a memory for previously storing the user information of the user who is presumed to use the image transfer apparatus 650. Since the contents of the user information are substantially the same as those described in FIG. 2, their explanation is omitted here.

The user information identification return section 62 is a portion constructed as follows. When the user information obtaining request notification is received from the network control section 63, the connection permission/non-permission to the image transfer apparatus 650 is discriminated from the ID, password, and the like of the image transfer apparatus 650 included in the signal. If it is determined that the connection is not permitted, the connection non-permission notification is sent to the network control section 63. If it is determined that the connection is permitted, the inputted user ID is collated with the user ID stored in the user information storing section 61, thereby making the user authentication. If the authentication failed, the authentication failure notification is sent to the network control section 63. If the authentication is successful, the corresponding user information is read out of the user information storing section 61 and sent to the network control section 63. This portion is a portion displayed as a block showing a computer control function of the authentication server 750 which is formed when the CPU (not shown) activates and executes the predetermined control program which has previously been stored in the ROM (not shown).

When the user information obtaining request signal is received from the image transfer apparatus 650 through the network 200, the network control section 63 sends the user information obtaining request notification to the user information identification return section 62. When the connection non-permission notification is received from the user information identification return section 62, the network control section 63 transmits the connection non-permission signal to the PC 150. When the authentication failure notification is received, the network control section 63 sends the authentication failure notification signal to the PC 150. When the user information is received, the network control section 63 transmits the user information signal to the PC 150. Further, the network control section 63 is a portion for receiving the image information packet whose contents are the image information obtained after the end of the printing from the image transfer apparatus 650 and storing the image information into an image information storing section 64. This portion is a portion displayed as a block showing the computer control function of the authentication server 750 which is formed when the CPU (not shown) activates and executes the predetermined control program which has previously been stored in the ROM (not shown). Further, this portion has a circuit board having a network interface function for communication-connecting the authentication server 750 to the network 200 on the basis of a predetermined protocol.

The image information storing section 64 is a memory for receiving the image information which has been obtained after the end of the printing and received from the image transfer apparatus 650 by the network control section 63 through the network 200 and storing.

The PC 150 is an upper apparatus constructed in such a manner that when the user ID is received from the user who requests the use of the image transfer apparatus 650, a user ID signal is transmitted to the image transfer apparatus 650, and permission of the use is requested. The PC 150 is also an upper apparatus constructed in such a manner that when the connection non-permission signal or the authentication failure notification signal is received from the authentication server 750, such a fact is displayed to the user so as to execute the process again. Further, the PC 150 is an upper apparatus constructed in such a manner that when the image information transmission permission signal is received from the image transfer apparatus 650, the image information packet whose contents are the image information to which the user requests the printing process is formed and transmitted to the image transfer apparatus 650 by E-mail. Generally, a personal computer is used as a PC 150. The network 200 is a communication network for communication-connecting the image transfer apparatus 650, authentication server 750, and PC 150 on the basis of a predetermined protocol.

The operation of the image processing system 900 of the embodiment 4 described above will now be explained with reference to flowcharts. First, the authenticating operation of the user who requests the use of the image transfer apparatus 650 will be explained. Subsequently, the operation to transmit a predetermined packet (image information) to the authentication server 750 from the PC 150 through the image transfer apparatus 650 by E-mail will be explained.

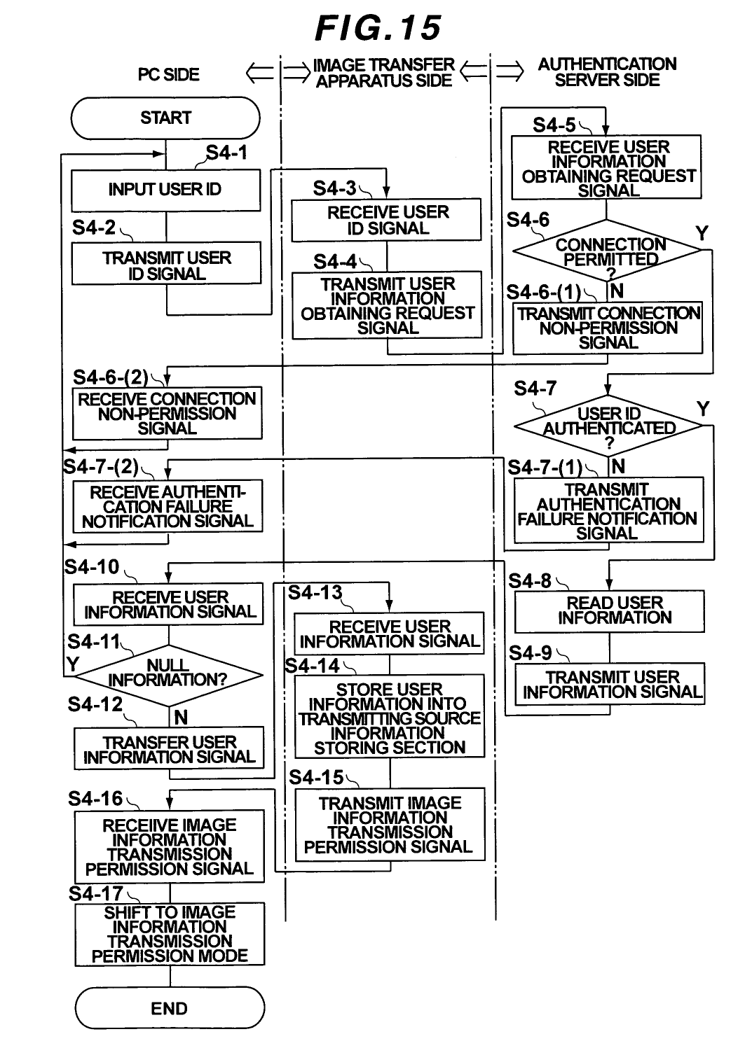

FIG. 15 is the flowchart for a user identifying process in the image processing system of the embodiment 4.

In the flowchart, a processing routine shown on the PC side shows the operation in the PC 150 (FIG. 14), a processing routine shown on the image transfer apparatus side shows the operation in the image transfer apparatus 650 (FIG. 14), and a processing routine shown on the authentication server side shows the operation in the authentication server 750 (FIG. 14). Communication among the image transfer apparatus 650, authentication server 750, and PC 150 is made through the network 200 (FIG. 14). The operation for the user identifying process will be described hereinbelow in order of steps S4-1 to S4-17 (which coincides with order of elapsed time) shown in FIG. 15.

Step S4-1:

The PC 150 (FIG. 14) is in the standby mode for waiting until the user who requests the use of the image transfer apparatus 650 (FIG. 14) inputs his own user ID. At this time, a message showing the waiting for the input of the user ID is displayed on a operation panel (not shown) of the PC 150 (FIG. 14). When the input of his own user ID to the operation panel (not shown) by the user is completed, step S4-2 follows. The standby mode is held until the completion of the input.

Step S4-2:

The PC 150 (FIG. 14) transmits the user ID signal to the image transfer apparatus 650 (FIG. 14) through the network 200.

Step S4-3:

The network control section 57 (FIG. 14) receives the user ID signal through the network 200.

Step S4-4:

When the user ID of the user who requests the use of the image transfer apparatus 650 (FIG. 14) is received from the network control section 57 (FIG. 14), the user inquiry section 56 (FIG. 14) sends the user information obtaining request notification for requesting the user authentication and the obtainment of the user information to the network control section 57 (FIG. 14). When the user information obtaining request notification is received from the user inquiry section 56 (FIG. 14), the network control section 57 (FIG. 14) forms the user information obtaining request signal including the user ID, the ID of the image transfer apparatus, and the password and transmits such a signal to the authentication server 750 (FIG. 14) through the network 200 (FIG. 14).

Step S4-5:

The network control section 63 (FIG. 14) receives the user information obtaining request signal through the network 200 (FIG. 14) and transmits the user information obtaining request notification to the user information identification return section 62 (FIG. 14).

Step S4-6:

When the user information obtaining request notification is received from the network control section 63 (FIG. 14), the user information identification return section 62 (FIG. 14) discriminates the connection permission/non-permission from the ID, password, and the like of the image transfer apparatus included in the signal. If it is determined that the connection is permitted, step S4-7 follows. If it is determined that the connection is not permitted, step S4-6-(1) follows.

Step S4-6-(1):

When the user information identification return section 62 (FIG. 14) sends the non-permission notification to the network control section 63 (FIG. 14), the network control section 63 (FIG. 14) forms the connection non-permission signal and transmits it to the PC 150 (FIG. 14) through the network 200 (FIG. 14).

Step S4-6-(2):

When the connection non-permission signal is received, the PC 150 (FIG. 14) is returned to step S4-1 and allows the operation panel to be returned to the standby mode for waiting for the user ID input.

Step S4-7:

The user information identification return section 62 (FIG. 14) compares the inputted user ID with the user ID stored in the user information storing section 61 (FIG. 14), thereby making the user authentication. If the authentication is successful, step S4-8 follows. If the authentication failed, step S4-7-(1) follows.

Step S4-7-(1):

When the user information identification return section 62 (FIG. 14) sends the authentication failure notification to the network control section 63 (FIG. 14), the network control section 63 (FIG. 14) forms the authentication failure notification signal and transmits it to the PC 150 (FIG. 14) through the network 200 (FIG. 14).

Step S4-7-(2):

When the authentication failure notification signal is received, the PC 150 (FIG. 14) is returned to step S4-1 and allows the operation panel to be returned to the standby mode for waiting for the user ID input.

Step S4-8:

The user information identification return section 62 (FIG. 14) reads out the corresponding user information from the user information storing section 61 (FIG. 14) and sends it to the network control section 63 (FIG. 14).

Step S4-9:

When the corresponding user information is received, the user information identification return section 62 (FIG. 14) sends the user information to the network control section 63 (FIG. 14). The network control section 63 (FIG. 14) forms the user information signal and transmits it to the PC 150 (FIG. 14) through the network 200 (FIG. 14).

Step S4-10:

When the user information signal is received, the PC 150 (FIG. 14) displays the user information to the operation panel (not shown) and requests the user to make a discrimination.

Step S4-11:

If the user information is NULL information, the processing routine is returned to step S4-1 and the operation panel is returned to the standby mode for waiting for the user ID input. If the user information is normal information, step S4-12 follows.

Step S4-12:

The PC 150 (FIG. 14) transfers the user information signal to the image transfer apparatus 650 (FIG. 14) through the network 200 (FIG. 14).

Step S4-13:

When the user information signal is received through the network 200 (FIG. 14), the network control section 57 (FIG. 14) sends the user information to the user inquiry section 56 (FIG. 14).

Step S4-14:

The user inquiry section 56 (FIG. 14) allows the received user information signal to be temporarily stored into the transmitting source information storing section 55 (FIG. 14).

Step S4-15:

When the user inquiry section 56 (FIG. 14) sends an image information transmission permission notification to the network control section 57 (FIG. 14), the network control section 57 (FIG. 14) transmits an image information transmission permission signal to the PC 150 (FIG. 14) through the network 200 (FIG. 14).

Step S4-16:

The PC 150 (FIG. 14) receives the image information transmission permission signal through the network 200 (FIG. 14).

Step S4-17:

The PC 150 (FIG. 14) advances to an image information transmission permission mode and the processing routine is finished.

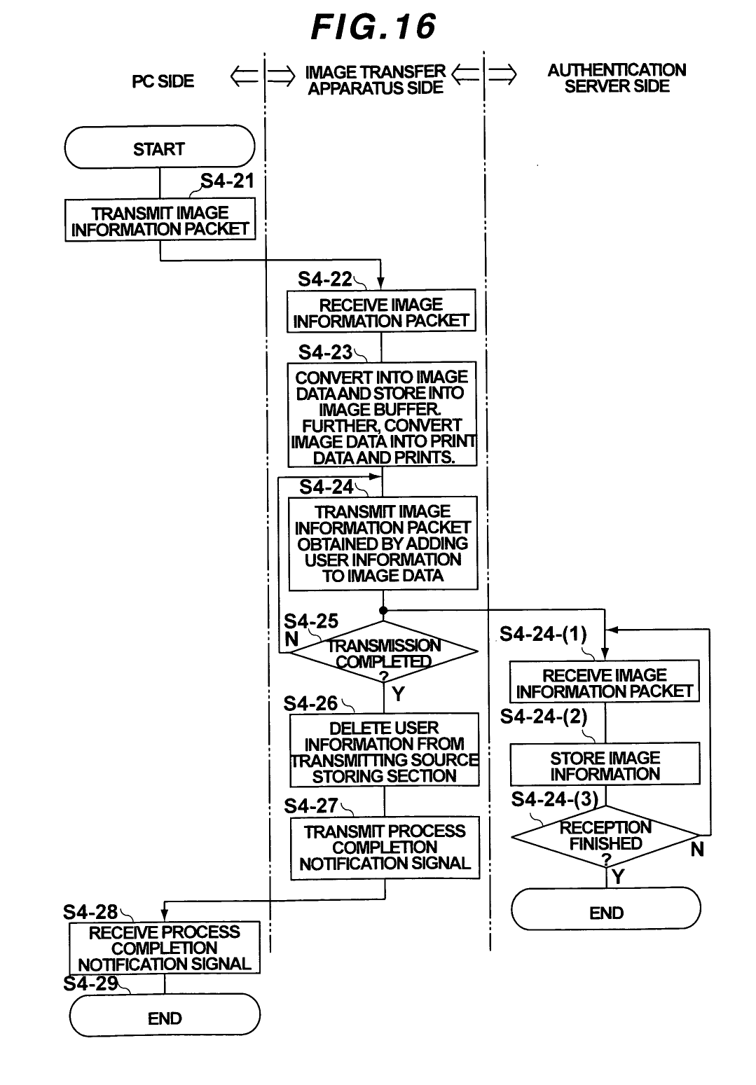

FIG. 16 is the flowchart for the E-mail transmitting process in the embodiment 4.

The operation for the E-mail transmitting process will be described hereinbelow in order of steps S4-21 to S4-29 shown in FIG. 16.

In the flowchart, a processing routine shown on the PC side shows the operation in the PC 150 (FIG. 14), a processing routine shown on the image transfer apparatus side shows the operation in the image transfer apparatus 650 (FIG. 14), and a processing routine shown on the authentication server side shows the operation in the authentication server 750 (FIG. 14). Communication among the image transfer apparatus 650, authentication server 750, and PC 150 is made through the network 200 (FIG. 14). The operation for the E-mail transmitting process will be described hereinbelow in order of steps S4-21 to S4-29 (which coincides with order of operation) shown in FIG. 16.

Step S4-21:

The PC 150 (FIG. 14) starts the E-mail transmission of the image information packet whose contents are the image information to be transmitted through the network 200 (FIG. 14).

Step S4-22:

The network control section 57 (FIG. 14) receives the image information packet whose contents are the image information through the network 200 (FIG. 14) and sends it to the image processing section 52 (FIG. 14).

Step S4-23:

The image processing section 52 (FIG. 14) converts the image information into the image data and sends it to the image buffer 53 (FIG. 14) so as to store the image data. Further, the image processing section 52 converts the image data into the print data and sends it to the print mechanism section 58 (FIG. 14) so as to execute the printing process.

Step S4-24:

The network control section 57 (FIG. 14) forms an image information packet obtained by adding the user name and the E-mail address stored in the transmitting source information storing section 55 (FIG. 14) to the image data stored in the image buffer 53 (FIG. 14), transmits the packet to the authentication server 750 (FIG. 14) through the network 200 (FIG. 14), and advances to steps S4-24-(1) and S4-25.

Step S4-24-(1):

The network control section 63 (FIG. 14) receives the image information packet and sends the image information to the image information storing section 64 (FIG. 14).

Step S4-24-(2):

The image information storing section 64 (FIG. 14) receives the image information and stores it.

Step S4-24-(3):

Processes of steps S4-24-(1) to S4-24-(3) are repeated until the image information storing section 64 (FIG. 14) receives all of the image information and stores them. When all of the image information has been stored, the processing routine of the authentication server 750 (FIG. 14) is finished.

Step S4-25:

Processes of steps S4-24 and S4-25 are repeated until the transmission of the image information packet is completed. When the transmission is completed, the processing routine advances to step S4-26.

Step S4-26:

When the transmission of the image information packet is completed, the network control section 57 (FIG. 14) sends the user information deletion request notification to the transmitting source information storing section 55 (FIG. 14) so as to delete the user information.

Step S4-27:

The network control section 57 (FIG. 14) sends a process completion notification signal to the PC 150 (FIG. 14) through the network 200.

Step S4-28:

When the process completion notification signal is received through the network 200, the PC 150 (FIG. 14) displays such a fact onto the display panel (not shown) and the processing routine is finished.

As described above, there is obtained such an effect that the invention can be applied not only to the case where the image reading apparatus reads the image information from the original image and sends it to the predetermined PC as shown in the embodiments 1 to 3 but also to the case where, according to the embodiment 4, the printer receives the predetermined image information from the PC through the network (the printer itself can also read the image information), prints the received image, and thereafter, transfers it to the predetermined server (or predetermined PC).

Although the embodiments have been described above with respect to the case where the invention is applied to the scanner which reads the original image and transmits the image information or the printer which receives the image data from the upper apparatus, the invention is not limited to such examples. That is, the invention can be applied to a facsimile apparatus, a copying apparatus, or the like.

It should be understood by those skilled in the art that various modifications, combinations, sub-combinations and alterations may occur depending on design requirements and other factors insofar as they are within the scope of the appended claims or the equivalents thereof.

What is claimed is:

1. An image reading apparatus which has an image reading section for reading image information from an image of an original document and transmits the image information read by said image reading section to a predetermined apparatus, comprising:
a user information storing section which preliminarily stores user information of a user who is presumed to use said image reading apparatus;
a user identifying section which authenticates said user on the basis of identification information that is inputted by the user who requests transmission of said image information and the user information stored in said user information storing section; and
a network control section which transmits the image information read by said image reading section to said predetermined apparatus,
wherein when said user identifying section authenticates said user, said network control section adds the user information of said user to said image information and transmits the resultant image information to said predetermined apparatus.

2. The image reading apparatus according to claim 1,
wherein said user information storing section comprises an external storing apparatus which is detachably connected to said image reading apparatus.

3. The image reading apparatus according to claim 2,
wherein said external storing apparatus further has a user setting information storing section which stores information whose settings can be arbitrarily changed by said user.

4. The image reading apparatus according to claim 1,
wherein said user information storing section stores a user ID serving the identification information.

5. The image reading apparatus according to claim 4, further comprising:
an operation panel to input the identification information.

6. The image reading apparatus according to claim 5,
wherein said user identifying section, when identified that an inputted user ID is different from the user ID stored in the user information storing section, executes a display of a message on said operation panel.

7. The image reading apparatus according to claim 5,
wherein said user identifying section, when identified that an inputted user ID is coincident with the user ID stored in the user information storing section, executes a display of a message indicating that the image information can be read on said operation panel.

8. The image reading apparatus according to claim 5,
wherein said user identifying section, when received a deletion instruction if said identification information from said operation panel, executes a deletion of said identification information and transmits a user information deletion end notification to said operation panel.

9. The image reading apparatus according to claim 5, further comprising:
an interface section to connect an attachable and removable memory storing user information,
wherein said interface section monitors whether said attachable and removable memory is connected, if it is not, executes a display of memory connection waiting on said operation panel; and if it is, outputs a connection end notification.

10. The image reading apparatus according to claim 9,
wherein said user identifying section, when identified that an user ID contained in said user information stored in said attachable and removable memory is different from the user ID stored in the user information storing section, transmits an identification failure notification and executes a display of a message indicating said identification failure notification and a memory connection waiting on said operation panel.

11. The image reading apparatus according to claim 9,
wherein said attachable and removable memory has a user setting storing section to store a transmission destination e-mail address and a user identification information storing section to store a user name serving as user information;
when said user identifying section identified that an user ID contained in said user information stored in said attachable and removable memory is coincident with the user ID stored in the user information storing section, said interface section reads out said transmission destination e-mail address and said user name and said network control section adds said user name into said image information and transmits said image information added said user name according to said transmission destination e-mail address.

12. The image reading apparatus according to claim 1, further comprising:
a transmission information storing section to store previously an e-mail address of said image reading apparatus,
wherein said network control section adds said user information and said e-mail address into said image information and transmits the image information added the user information and said e-mail address.

13. An image processing system including an authentication server which authenticates a user and an image reading apparatus which transmits image information read out from an image of an original document to a predetermined apparatus, wherein
said authentication server has
a user information storing section which preliminarily stores user information of the user who is presumed to use said image processing system and
a user information identification return section which authenticates said user on the basis of identification information that is inputted by the user who requests transmission of the image information from said image reading apparatus and the user information stored in said user information storing section and transmits a result of said authentication to said image reading apparatus, and
said image reading apparatus has
a user inquiry section which transmits the user identification information that is inputted by the user who requests the transmission of said image information to said authentication server and requests the authentication result of said system user and
a network control section which, when said user information identification return section authenticates said user, adds the user information of the authenticated user to said image information and transmits the resultant image information to said predetermined apparatus.

14. An image processing system including an authentication server which authenticates a user and an image transfer apparatus which prints and outputs image information received from a first apparatus and transmits said printed and outputted image information to a second apparatus, wherein
said authentication server has
a user information storing section which preliminarily stores user information of the user who is presumed to use said image processing system and
a user information identification return section which authenticates said user on the basis of identification information that is inputted by the user who requests transmission of the image information received from said first apparatus and the user information stored in said user information storing section and transmits a result of said authentication to said image transfer apparatus, and
said image transfer apparatus has
a user inquiry section which transmits the identification information that is inputted by the user who requests the transmission of the printed and outputted image information to said authentication server and requests the authentication result of said user and
a communication control section which, when said user information identification return section authenticates said user, adds the user information of the authenticated user to said image information and transmits the image information added the user information to said second apparatus.
